(19) United States
(12) Patent Application Publication
(10) Pub. No.: US 2025/0306684 A1
(43) Pub. Date: Oct. 2, 2025

(54) Generating Targetable Remote Haptic Sensations using Through Body Mechanical Waves

(71) Applicant: Meta Platforms Technologies, LLC, Menlo Park, CA (US)

(72) Inventors: Karthik YOGEESWARAN, San Carlos, CA (US); Chiara DARAIO, South Pasadena, CA (US); Andrew Arthur STANLEY, Seattle, WA (US); Jessica HARTCHER-O’BRIEN, Redmond, WA (US); Andrew AKERSON, Los Angeles, CA (US)

(21) Appl. No.: 19/035,295

(22) Filed: Jan. 23, 2025

Related U.S. Application Data
(60) Provisional application No. 63/570,003, filed on Mar. 26, 2024.

(51) Int. Cl. G06F 3/01

(52) U.S. Cl. CPC G06F 3/016; G06F 3/014; G06F 3/013

(57) ABSTRACT

A device worn on the human body can stimulate targeted mechanoreceptors from a distance beyond their receptive fields through use of modulated mechanical waves transmitted from an array of transducers which generate one or more specific subsurface strains at the target mechanoreceptors.

### CROSS-REFERENCE TO RELATED APPLICATIONS

This application claims priority to U.S. Patent Provisional Application No. 63/570,003, titled “Generating Targetable Remote Haptic Sensations using Through Body Mechanical Waves,” filed on Mar. 26, 2024, which is herein incorporated by reference in its entirety.

### TECHNICAL FIELD

The present disclosure is directed to providing haptic sensations from mechanical waves generated using remotely located actuators.

### BACKGROUND

Human tactile perception relies on a number of types of mechanoreceptors. Each type of mechanoreceptor is sensitive to specific surface stimuli (decomposed into frequency content and duration). Deforming the mechanoreceptor generates electrical signals to be transmitted to the brain. Prior studies have explored the magnitude of perceptual response of each type of mechanoreceptor to stimuli generated at the skin surface.

The region around a mechanoreceptor where a surface stimulus can cause a mechanoreceptor to fire is referred to as the receptive field of the mechanoreceptor, with the firing rate becoming less frequent as the stimulation location moves away from the mechanoreceptor. The brain relies on knowledge of the receptive field for each mechanoreceptor to infer the location of a stimulus.

In normal direct contact interactions that generate local tactile stimulations, contact deformations generate specific subsurface strain fields in a given tissue volume containing mechanoreceptors in the proximity of the contact. Such generated strain fields vary with distance from the point of contact. At some distance from the point of contact, the subsurface strain fields are no longer able to adequately deform and stimulate the mechanoreceptors.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 3 is a block diagram illustrating an overview of an environment in which some implementations of the present technology can operate.

FIG. 4 illustrates an example system block diagrams for inducing remote haptic stimulation using in-situ measured channel information.

FIG. 5 illustrates an example channel sounding data collected at a pair of neighboring locations on the hand from one transducer at the wrist using a 50-500 Hz chirp sounding signal.

FIG. 6 illustrates an example of opposing tangential displacements measured at two points on the surface to either side above the targeted mechanoreceptor.

FIG. 7 illustrates example transmit waveforms with and without masking.

FIG. 8 illustrates example block diagrams pertaining to calibration techniques.

FIG. 9 illustrates an example block diagram pertaining to selection of generation of channel matrix.

FIG. 10 illustrates an example block diagram pertaining to generation of stimulus signals.

The techniques introduced here may be better understood by referring to the following Detailed Description in conjunction with the accompanying drawings, in which like reference numerals indicate identical or functionally similar elements.

### DETAILED DESCRIPTION

The goals of haptic feedback are to either communicate information to a user without the use of an audio/visual message (for example using a vibration to inform of an incoming call) or to provide sensations to users as they interact with virtual objects (to both increase immersion in a virtual environment and to better facilitate manipulation of virtual objects). Generation of remote haptic sensations has been a long desired goal for augmented reality applications and within the human computer interface space generally to provide haptic feedback, while not encumbering the region of stimulation (ex: human hand).

Earlier attempts to generate remote haptic perception have relied on illusion (this is sometimes called ‘referred haptics’). In these cases, visual, auditory or tactile stimuli is provided to the user as they interact with virtual objects which trick the user into feeling like a virtual object is present by relying on their prior experience in interacting with similar real world objects. These illusion based haptics can be convincing but typically do not generalize beyond a specific context and are unable to aid in the handling of virtual objects while the user's gaze is directed elsewhere.

Some prior attempts at remote haptic stimulation have relied on modulating ultrasonic waves in air to generate focused pressure waves in the region of a virtual object. In another example, surface waves excited on a manufactured surface generate surface displacements in the region of a virtual object through elastic waves. These techniques can indeed stimulate mechanoreceptors remotely from the location of the actuators. However, these approaches are not viable for practical wearable devices as they rely on large off-body structures.

Some prior attempts at remote haptic stimulation have relied on directly electrically stimulating neurons within the human body or by inducing structural resonances within the human body (in the latter case large vibrations are generated within body structures such as tendons which deform mechanoreceptors proximate to the resonant structures inducing remote sensations). While both of these methods generate remote haptic stimulation in a potentially wearable form factor, these methods are unable to provide fine control and targeting of sensations as they can only coarsely stimulate large structures within the body.

To stimulate a mechanoreceptor from beyond its receptive field, one must provide a method of generating a desired subsurface strain field at an arbitrary distance away from a set of actuators. The technology described in this disclosure is a radical departure from the above described methods and provides a first of its kind mechanism for stimulating arbitrarily selected mechanoreceptors with actuators placed beyond their receptive fields, using the human body as a channel for propagating mechanical waves. Disclosed herein is a device worn on the human body that can stimulate targeted mechanoreceptors from a distance beyond their receptive fields through use of modulated mechanical waves transmitted from an array of transducers which generate one or more specific subsurface strains at the target mechanoreceptors.

While the following descriptions of systems and methods for remote haptic stimulation specifically describe a device intended to provide haptic stimulation on the hand from the wrist, the disclosed technology is more general and can be applied to many other parts of the body such as a stimulus on the face from an array embedded in the leg of a pair of glasses or a stimulus on a foot from a device worn at the ankle.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

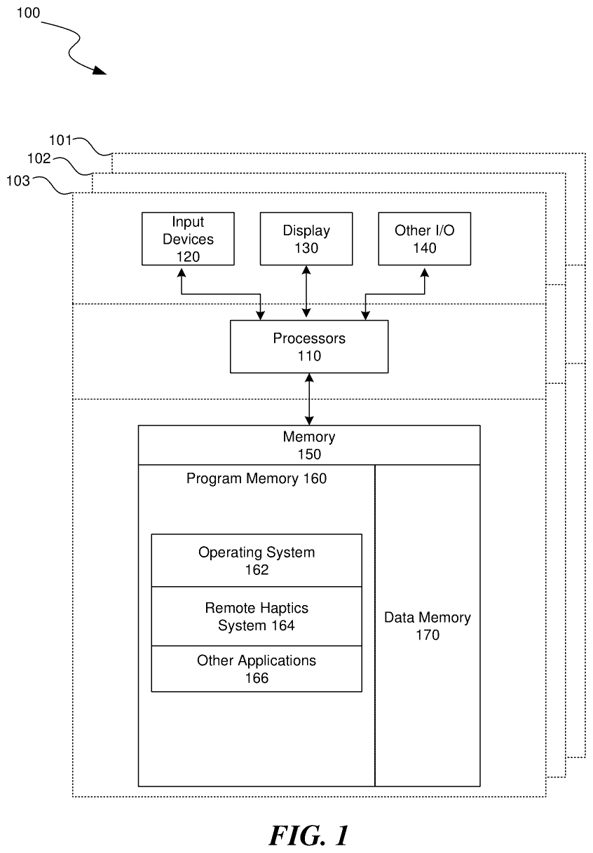

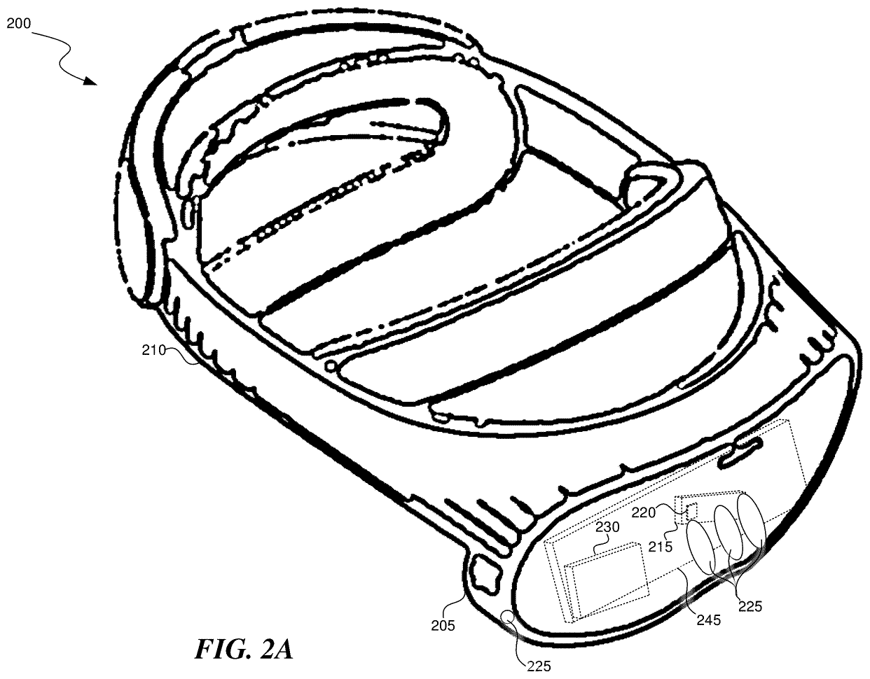

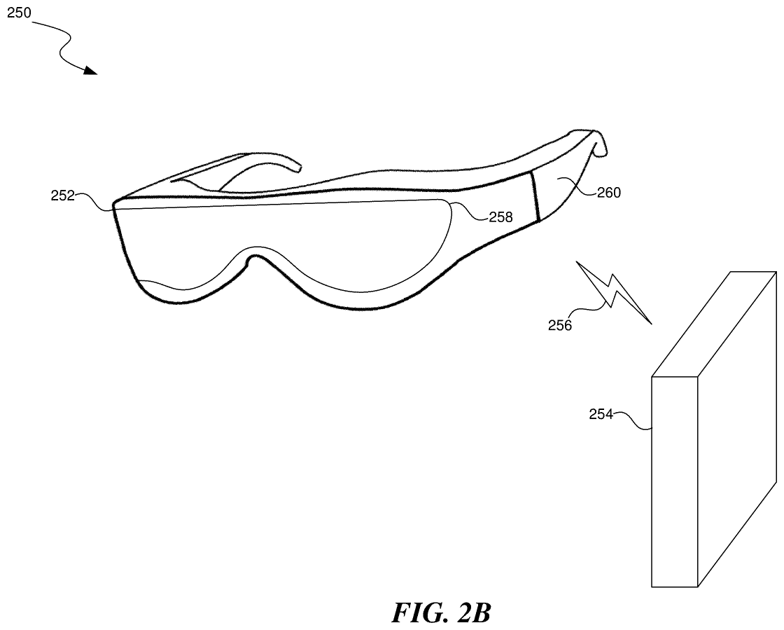

Several implementations are discussed below in more detail in reference to the figures. FIG. 1 is a block diagram illustrating an overview of devices on which some implementations of the disclosed technology can operate. The devices can comprise hardware components of a computing system 100 that provides haptic sensations from mechanical waves generated using remotely located actuators. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, remote haptics system 164, and other application programs 166. Memory 150 can also include data memory 170, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an artificial reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHZ link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects. The compute units 230 in the HMD 200 or the core processing component 254 can monitor hand positions and motions of the user.

In various implementations, the HMD 200 of FIG. 2A or 250 of FIG. 2B can also include additional subsystems, such as an eye tracking unit, an audio system, various network components, etc., to monitor indications of user interactions and intentions. For example, in some implementations, instead of or in addition to controllers, one or more cameras included in the HMD 200 of FIG. 2A or 250 of FIG. 2B, or from external cameras, can monitor the positions and poses of the user's hands to determine gestures and other hand and body motions. As another example, one or more light sources can illuminate either or both of the user's eyes and the HMD 200 of FIG. 2A or 250 of FIG. 2B can use eye-facing cameras to capture a reflection of this light to determine eye position (e.g., based on set of reflections around the user's cornea), modeling the user's eye and determining a gaze direction.

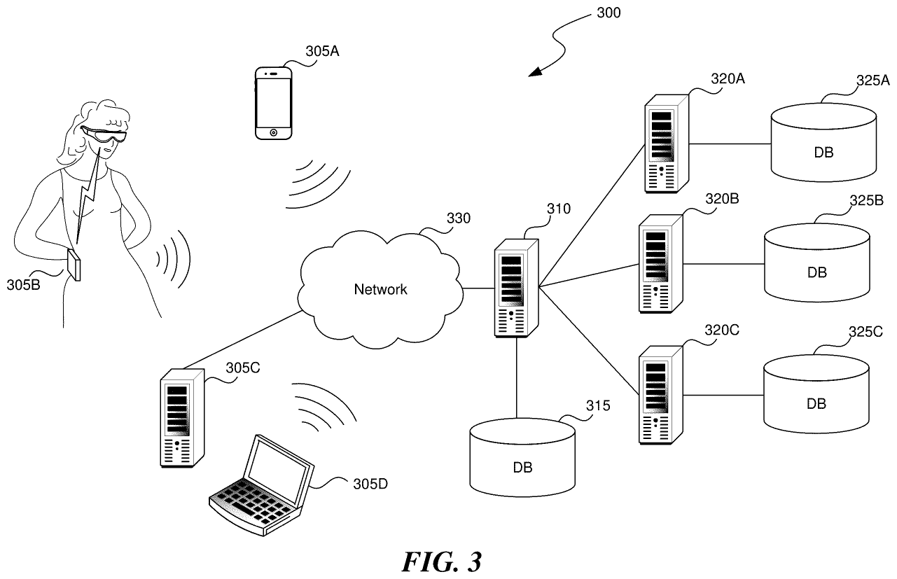

FIG. 3 is a block diagram illustrating an overview of an environment 300 in which some implementations of the disclosed technology can operate. Environment 300 can include one or more client computing devices 305A-D, examples of which can include computing system 100 of FIG. 1. In some implementations, some of the client computing devices (e.g., client computing device 305B) can be the HMD 200 of FIG. 2A or 250 of FIG. 2B. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100 of FIG. 1. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

Principle of Operation: Stimulation of Remote Mechanoreceptors with In-Situ Measured Channel

The technology described in this disclosure uses mechanical waves to stimulate perception on targeted mechanoreceptors. Mechanical waves may propagate in a substrate through a number of modes. The type of modes which can propagate through a medium and their respective properties, such as wavelength, depend on the composition and dimensions of the substrate.

To generate a desired strain field that stimulates a target mechanoreceptor at a distance from the source transducers, we can apply a combination of both low attenuation (to provide adequate displacements at a distance from the source) and a specific range of wavelengths. Wavelengths can be short enough to independently control to two or more nearby points while at the same time wavelengths can be long enough relative to structures within the channel medium to avoid significant scattering at boundaries which would make channel prediction very challenging. The human hand has favorable (<1 dB/cm) attenuation characteristics at a number of frequencies including below 1 kHz for shear waves and in the ultrasonic regime below a Megahertz for pressure waves. In these ranges the wavelengths have been measured to be in the range of centimeters to millimeters which is appropriate for the disclosed technology. Other frequency ranges may be used as well, especially where they adhere to the aforementioned criteria of favorable channel attenuation and appropriate wavelength.

While the rest of this disclosure will focus on the frequencies below 1 kHz, we contemplate applying these techniques to the ultrasonic regime and provide remote haptic stimulation by utilizing the acoustic radiation force in conjunction with this technology.

To focus a signal at a distance away from an array of transducers, a number of focusing techniques may be used. At frequencies below 1 kHz, the hand is a heterogeneously dispersive medium with little to no multipath or scattering. This combined with the complex geometry render simple phased array or scattering based focusing techniques unusable.

One method to harness the specific channel characteristics is to utilize the dispersive medium to focus an impulse signal. As an impulse is composed of various frequency components aligned in phase, and because of the variation of velocity of each frequency component, one could transmit each frequency component of a signal at a specifically chosen phase such that at a given target location, the phases align to form an impulse.

Amongst the various types of mechanoreceptors is a class referred to as rapidly adapting. These mechanoreceptors can respond to transients and higher frequency vibrations (ranging from tens to hundreds of Hertz) and so are well suited to stimulation through the focusing of impulses.

While the rest of this disclosure will specifically address the stimulation of rapidly adapting mechanoreceptors, we contemplate adapting these techniques to generate the desired strain fields which may be used to stimulate slowly adapting mechanoreceptors. Additionally, these techniques can be adapted to stimulate thermal receptors in the skin. While the disclosure mainly discusses the use of impulses and pulse trains, the methods to generate the systems and methods described can easily generate other waveforms within the bandwidth constraints of the channel at a given target that elicit other percepts.

Stimulation of rapidly adapting mechanoreceptors can be achieved through the compression and elongation of the mechanoreceptor. While it is not practical to directly measure and focus a specific subsurface strain field, we can estimate using an analytical model or simulate what surface displacement vectors maximally generate the desired subsurface strain.

In one embodiment, using a linear elastic model we compress a rapidly adapting mechanoreceptor by applying opposing tangential displacements at two points on the surface with a half width of d/√2 where d is the depth of the target mechanoreceptor below the surface.

In another embodiment, a 2D or 3D simulation of a mechanoreceptor embedded in the multilayer skin structure can be used to determine the spatio-temporal surface displacement map which results in maximal deformation of the mechanoreceptor.

Another approach to mimic actual touch is to determine the mutually dependent target location mechanoreceptor responses via 2nd order neural response simulations. From this we can extract the decomposition of the strain field-receptor responses into primary eigenvectors or dimensions. This output could then be used in conjunction with the previously mentioned approaches to determine the desired surface displacement vectors.

After using this technique of starting with the desired strain field at the targeted type or group of mechanoreceptors and then calculating the required displacements on the surface, the next step can be to determine how to focus signals from an array of transducers which generate these surface displacements at the target. Transmitting a simple impulse, sine wave or any other type wave from a single actuator does not predictably generate the strain field required to stimulate an arbitrarily selected mechanoreceptor beyond its receptive field. Neither will any basic single point focusing techniques which work with this specific medium (heterogeneous dispersion with no scattering). Instead, we can use a beamforming technique capable of independently focusing to more than one target displacement vector.

While the rest of this disclosure specifically discusses one type of beamforming capable of optimizing and focusing to more than one target displacement vector, we contemplate substituting different beamforming techniques while still using the systems and methods disclosed herein.

We can use multi-user precoding based single user antenna MIMO techniques. For this disclosure we use one specific type of MIMO, multi-user massive MIMO using zero forcing precoding with single antenna users, to provide an example technique by which more than one displacement vector may be targeted at a distance from an array of transducers. Zero forcing precoding works by determining the channel matrix between the array of transmitters and receivers and computing the pseudoinverse. When the ratio of transmitters to receivers is small, the matrix is not full rank and the inverse can fail. Using massive MIMO, showed that as the ratio of base station antennas to user antennas increases, the singular value spread falls ensuring orthogonality between user channels. Applying this same approach, an array of transducers can be selected with more than four transducers for each targeted displacement vector.

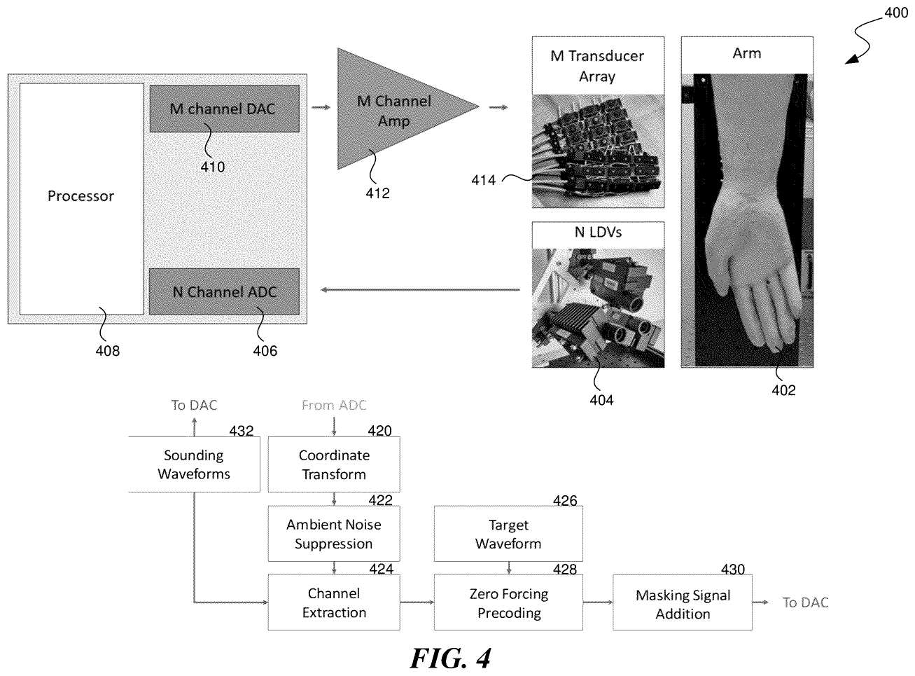

FIG. 4 illustrates an example system block diagram 400 for inducing remote haptic stimulation using in-situ measured channel information. In the upper portion of diagram 400, elements 402-414 illustrate the components of a remote haptic stimulation system. This remote haptic stimulation system starts with N laser doppler vibrometers (LDVs) that measure and calculate displacement vectors at a target on the arm 402. These are passed to N audio channels to digital converter (ADC) 406. The digital representations are then provided to processor (and associated computing components), along with sounding waveforms 432 an output channel matrix, as discussed below, which is passed to M channel DAC (multi-channel digital to analog converter) 410, along with the sounding waveforms 432. The analog results are passed to M channel amplifier(s) 412, and the amplified results are sent to an array of M transducers 414, which produce output waveforms which combine to create the desired sensation at the target.

In the lower portion of diagram 400, elements 420-432 illustrate the processing steps and results, e.g., performed by processor 408 and associated computing components (e.g., those illustrated in FIGS. 1-3). At block 420, a digital conversion (by N Channel ADC 406), of data received form the N LDVs 404, is received and block 420 performs a coordinate transformation on the received data to extract the tangential displacement on the axis between the target displacement points. Ambient noise suppression can then be performed at block 422. Once the ambient noise suppression is performed, using sounding waveforms 432, channels can be extracted at 424. Next, with these extracted channels and target waveform 426, zero forcing precoding can be performed at 428 to determine a channel matrix between the array of transmitters and receivers and computing the pseudoinverse. A masking signal is then applied at block 430, the result of which is provided to M channel DAC 410.

For an example case where targeting a rapidly adapting mechanoreceptor 2 mm below the skin surface, using the previously mentioned simple linear elastic model, a system can generate two opposing tangential displacement vectors separated by ˜2.8 mm using an array of more than 8 transducers. The simplest way to do this would be to measure the channel matrix H by using two or more laser doppler vibrometers pointed at each of the two displacement target points, performing a coordinate transformation on the received data to extract the tangential displacement on the axis between the two target displacement points and then transmitting a sounding signal (ex: chirp) at each of the transducers. The frequency bandwidth of operation (50 Hz to 1 kHz) is selected to meet the aforementioned criteria of wavelength and propagation loss with the 50 Hz component having wavelengths at the longer end of the usable band and the 1 kHz components suffering from significant attenuation. The transducer, its grounding, tactor/coupler can be selected to maximize energy transfer into the flesh over the entire frequency range in use.

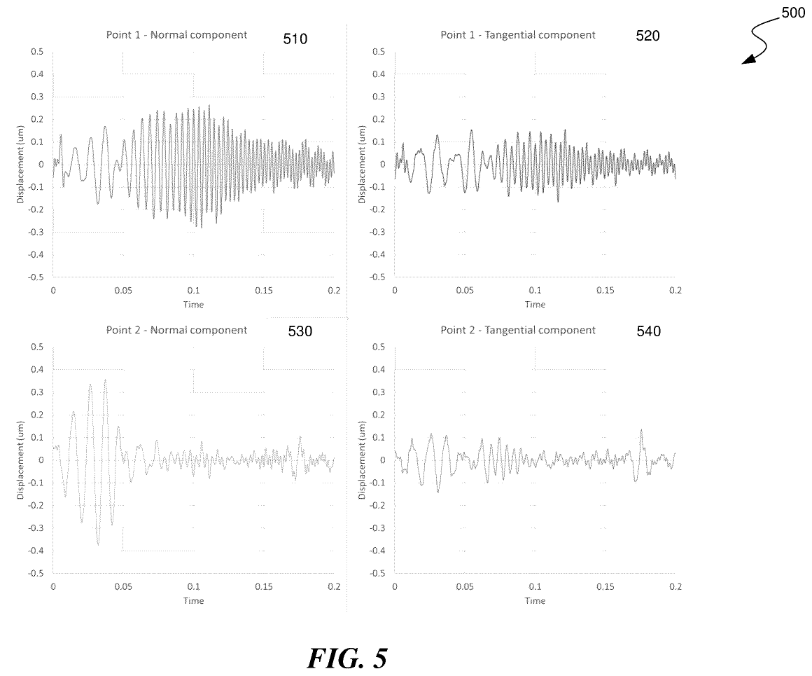

FIG. 5 illustrates examples 500 of channel sounding data collected at a pair of neighboring locations on the hand from one transducer at the wrist using a 50-500 Hz chirp sounding signal. For a first point of the pair of neighboring locations, graph 510 illustrates data collected for a normal component of the data collected and graph 520 illustrates data collected for a tangential component of the data collected. Similarly, for a second point of the pair of neighboring locations, graph 530 illustrates data collected for a normal component of the data collected and graph 540 illustrates data collected for a tangential component of the data collected. Similarly,

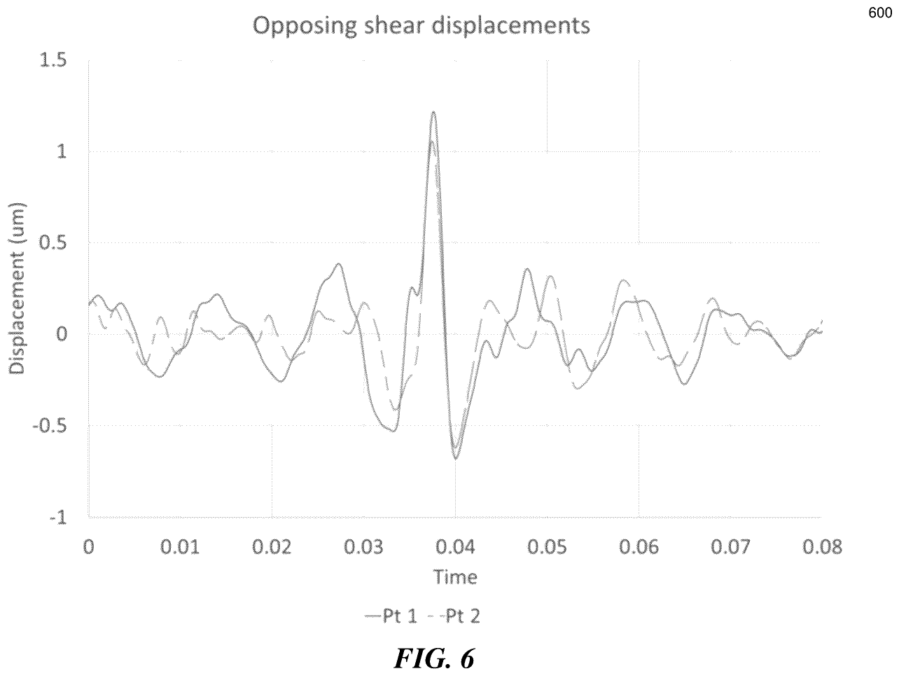

FIG. 6 illustrates graphs 600 for opposing tangential displacements measured at two points on the surface to either side above a targeted mechanoreceptor.

After collecting data from the vibrometer, performing the coordinate transform and selecting the appropriate tangential vectors, the Fourier transform is computed for both the sounding signal and received signals which are divided to determine the complex channel response between each pair of transducers and target displacement vectors. A channel matrix H is constructed from this data and the pseudo-inverse is calculated and power normalization is applied, generating the per frequency precoder P_{ZF}=(√Pt)*H^{H}(HH^{H})⁻¹/√(trace((HH^{H})⁻¹).

The per frequency source signal matrix s is generated by computing the Fourier transform of the desired signals. In this example we will use a pair of impulses which occur at the same time. The output waveform for each transducer is computed by calculating the inverse Fourier transform of the matrix X=P_{ZF}s. Transmitting the output waveforms generate the desired displacements at the target vectors.

Remote haptic stimulation has been generated in the aforementioned example case of opposing tangential displacements where the displacement of each vector is approximately 4 ms in duration and approximately 1 micron in displacement.

In other embodiments, varied perceptual responses can be generated by applying other strain fields. In one example, applying a pair of opposing normal displacements (one on the palmar side and one on the dorsal side) causes the user to feel a pressure under their skin.

In other embodiments, multi-touch sensations (i.e., sensations which occur at multiple locations simultaneously) in the target region may be created by using the same zero forcing precoding technique to target multiple locations in the target region. This can be achieved by using the appropriate displacement vectors for each target region and combining all of them in the channel matrix H.

When modifying the signal waveform to increase the number of pulses or to change the target stimulus wave shape one can set the occupied bandwidth of the source signal to not be significantly reduced, as a dispersion based spatial focusing technique is only able to localize a target displacement through the phase alignment of various frequency components. In cases where a repetitive pattern is to be used which is composed of a limited number of frequency subcomponents, jitter can be deliberately added to spread the signal content over a larger bandwidth, improving spatial focusing.

### Improving Salience of Remote Haptic Sensations

A problem overcome the disclosed system is that waveforms generated by a transducer array, for example at the wrist, a bulk of the precoder and signal waveform energy is in certain frequency bands, which result in low local mechanoreceptor stimulation. An example solution is to put more energy in the frequency range above 400 Hz where mechanoreceptors are less sensitive.

Another way to minimize perception of the local stimulus would be to spread the signal over a larger bandwidth. As the focusing occurs by compensating for the dispersion in the channel, the greater the delay spread of frequency content at the source, the lower the peak to average ratio and the less salient the local stimulus (i.e. making the signal at the source less of an impulse and more akin to white noise).

A further way to minimize local perception would be to apply a transducer gain leveling and suppression algorithm, where specific transducers are disabled or attenuated depending on their amplitude relative to other transducers or depending on their peak to average ratios.

Yet another way to improve the ratio of remote vs local perception would be to improve the salience of remote sensations by adding a spatio-temporal nature to the target stimulus, where for example the first sensation is perceived at location 1, the second sensation is perceived at a nearby location 2, the third sensation is perceived at a following location 3, and so on. It has been observed that users perceive the motion of a stimulus more strongly than a stationary one. To achieve this using the described technology, we add the relevant target vectors for each target location to the channel matrix H to generate the precoder. We then modify the signal waveforms for each set of vectors such that in the case of a pulse train, a transient at time t1 is used for vector set 1, a transient at time t2 is used for vector set 2 and so on.

Another way to minimize local sensation is to induce lateral inhibition in the wrist. Lateral inhibition is a phenomenon where the excitation of one type of mechanoreceptor causes the brain to reduce or cancel out the excitation of the neighboring mechanoreceptors. The result is highly localized percepts. This can be achieved, for example, by using a very slowly varying stimulation or static pressure at a location very close to each transducer.

Principle of Operation: Determining the Channel without In-Situ at Target Measurement

In the previous sections, the remote stimulation is achieved by operating on a channel matrix which is determined by transmitting sounding signals on each transducer in an array and using a number of laser doppler vibrometers (LDVs) to measure and calculate the displacement vectors at the target.

We can implement a wearable device which uses this technique by including a system that determines the channel response between the target surface displacement points around any arbitrarily selected stimulation point on the targeted region of the body and each transducer in the array.

In our human body based channel, at a frequency of operation below 1 kHz, we have little to no multipath. Thus, taking any two points on the body, the channel at each frequency can be estimated by dividing the body into a number of small elements on the order of the minimum wavelength of operation (˜5 mm), estimating the dispersion and attenuation of each block, and then aggregating the attenuation and velocity between the pair of points. This channel response is only modestly impacted by pose (unlike in a multipath dominated channel where even the smallest pose change results in a completely different channel response). For each point on the region of interest we will need channel information for all 3 axes of displacements.

The wearable device includes a system to collect the anthropometric data of the target human body region (in this example the human hand & wrist). This can be achieved by the commonly available camera based hand tracking system used on XR systems. Some other information about the user is collected to further aid in classification such as age. Pose data is collected and inferred from a hand tracking system such as EMG or a camera based hand tracking system. The region of the body is then classified into one of a number of bins based on these collected and measured critical parameters. For each bin we have a model map of the dispersion and attenuation for each of the 3 displacement vectors.

The database of model maps are created through a combination of simulations of muscle-accurate animated models vetted against a large data set of dispersion and attenuation maps collected from human subjects. Using commercially available muscle accurate human body models we generate large sets of CAD models which are meshed for use in simulation software. The simulation software uses representative values for stiffness, dissipation, attenuation, poisson's ratio etc. for each biological component (fat, tendon, bone etc.) and simulates the channel response over the dataset of poses. This process is repeated for variations of anthropometry and other variables like age. Data from human subjects are collected in parallel using a system including a scanning laser doppler vibrometer which allows 3 axis surface displacements to be measured at every point on a human test subject's limb surface while an array of actuators are used which generate sounding signals. Data from the human population collection is then used to refine the simulation output. With a final parameterized database of 3 axis dispersion maps for all variations of anthropometry and pose.

As a last step to ensure accuracy of the predicted channel we add some calibration steps. The first type of calibration is performed every time a user first puts on the transducer array. The goal of this step is to locate each transducer on the body. The user is directed to open a specific calibration application on their smartphone. The application will then direct the user to place various parts of their target limb on the surface of the smartphone. The smartphone will use its inbuilt vibration motor or speaker to emit a sounding signal. This sounding signal will be received at each transducer in the array. As a final step, each transducer in the array will fire a sounding signal in sequence with the remaining transducers in the array measuring the received signal.

For this above step to work, each transducer can perform reciprocal calibration. In the case of a piezo transducer, the transducer is bidirectional and can act as both transmitter and receiver making it natively capable of reciprocal calibration. In the case of a transducer which cannot act as receiver, a separate receiver chip (ex: IMU) will be placed in close proximity to the transducer, potentially within the tactor/coupler such that a known transfer function can be used to estimate the reciprocal channel from the data collected on the receiver chip.

An optional secondary device to aid in calibration is a sensor placed in a separate housing and worn in the vicinity of the region of stimulation. In the example case of a wrist worn transducer array targeting mechanoreceptors in the hand, the separate sensor may be placed in a ring form factor. As the device is only in use rarely and solely for the purpose of periodic calibration, the device may be low power and be powered by body heat using the Seebeck effect. To minimize disturbances to the user, calibration data can be collected once a day where each of the transducers fire a known sounding signal in sequence while the sensor collects data. Additionally, when the wristband device is used to send a non-remote haptic notification buzz to the user, the sensor can record this data for calibration use. This recorded calibration data can be transmitted to the wristband wirelessly using a low power wireless protocol such as BTLE.

The calibration data will be used to further refine the selected dispersion and attenuation model map and to estimate the locations of the transducers on the wrist. This is possible as the location of the transducers in the array can be tracked relative to each other and the calibration data is generated from a number of known locations on the target region.

In one embodiment the detailed anthropometric data, critical user data, pose information and calibration data can be sent to the cloud where a personalized model set is created to be used for extracting the channel data.

In another embodiment machine learning is used to select, adapt or generate the displacement and attenuation map based on anthropometric data, critical user data, pose information and calibration data.

In another embodiment, the calibration step will include some basic perception experiments directed by the smartphone calibration application to determine sensitivity of a given user to local stimulation at the array. This information will be used to personalize the transmit waveforms by adjusting the gains of the transmit waveform and masking signals.

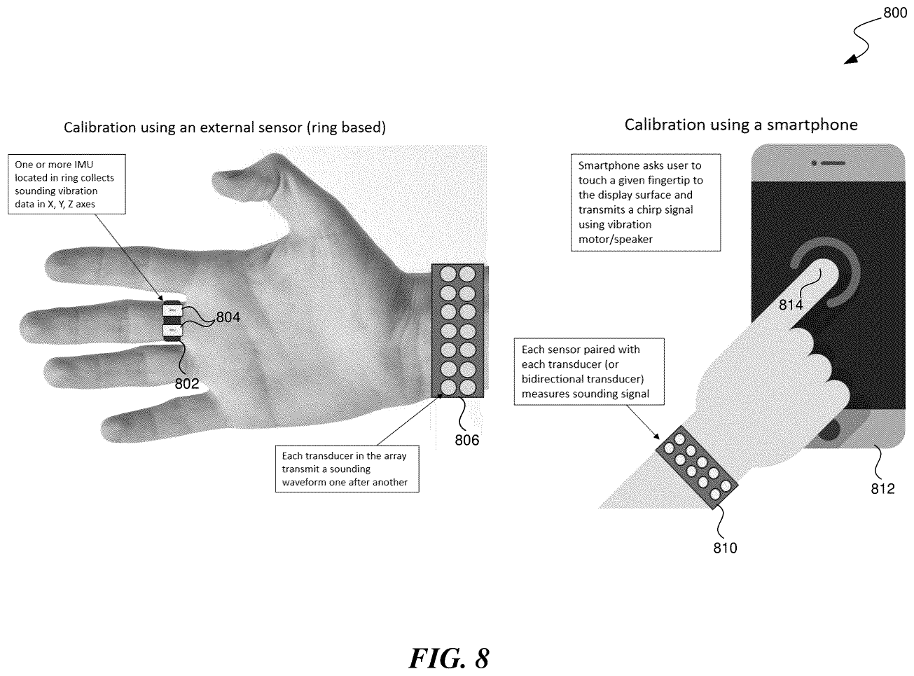

FIG. 800 illustrates various calibration techniques 800. The left side of FIG. 8 illustrates a calibration using a wearable device, such as ring 802, which includes IMU devices 804. As discussed above, each transducer, of a transducer array 806, can in succession transmit a sounding waveform. The IMUs 804 in the ring 802 can collect vibration data, corresponding to each transducer transmission, in each of the X, Y, and Z axes. These reading can then be used to calibrate system to locate each transducer on the body and/or to refine dispersion and attenuation model maps.

The right side of FIG. 8 illustrates a calibration using an external device, such as smartphone 812 (e.g., with a calibration application). The application can direct the user to place various parts of their target limb (e.g., fingertip 814) on the smartphone 812. The smartphone 812 can use an inbuilt vibration motor or speaker to emit a sounding signal. This sounding signal can be received at each transducer in transducer array 810. Each transducer can then fire a sounding signal in sequence with the remaining transducers in the array 810 measuring the received signal to calibrate system to locate each transducer on the body and/or to refine dispersion and attenuation model maps.

### General Operation

The system will continually track pose and adjust the dispersion and attenuation map set used for channel estimation. When an application chooses to send a remote haptic sensation, the target location in the hand is selected by the application which in turn uses a generic map of mechanoreceptor locations on the hand to determine the desired mechanoreceptor type and target strain field which is then used to determine the required displacement vectors. This data is then used to compute the precoder matrix.

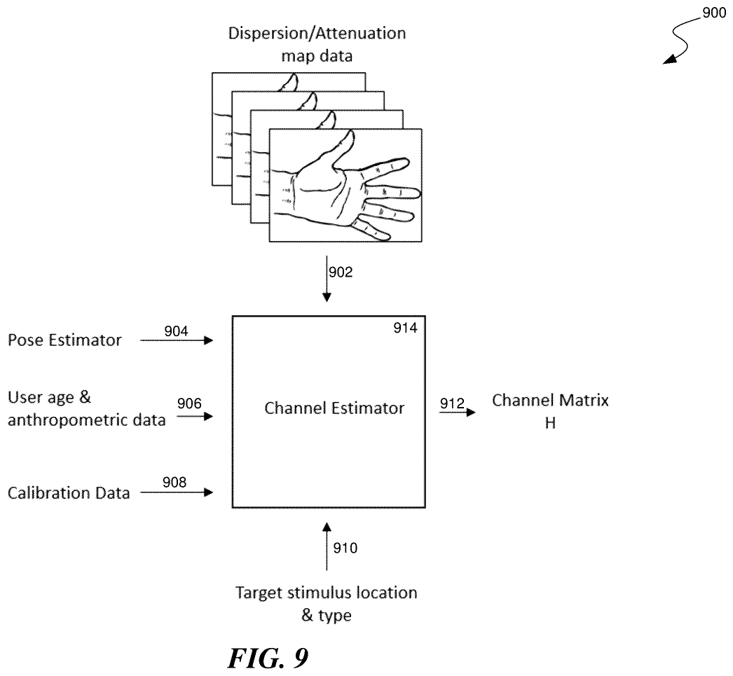

FIG. 9 illustrates a block diagram 900 of a channel estimator 914. Channel estimator 914 can receive dispersion/attenuation map data at 902, pose estimations at 904, user characteristics at 906, calibration data at 908, and target location and type data at 910. As discussed above, channel estimator can use these received data sets to produce channel matrix H at 912.

The application may also select the type of stimulus waveform and duration to correspond with the virtual objects which the user is interacting with. In other scenarios, haptic sensations may be used to change the perceived properties of an object which a user is grasping. Variables including amplitude, envelope, pulse repetition rate etc. may be selected and used to generate the corresponding signal waveforms.

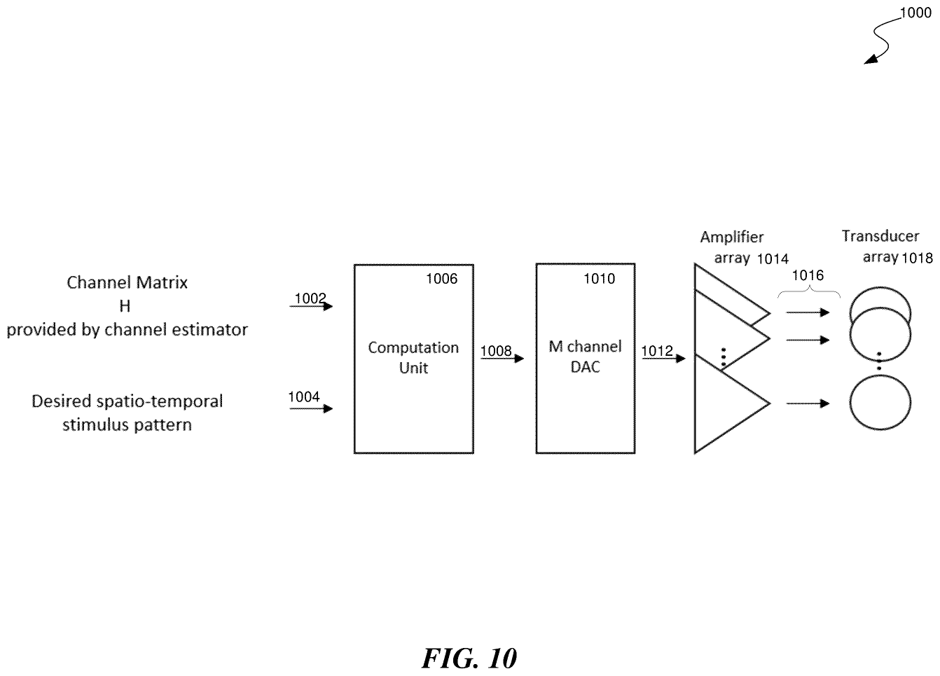

FIG. 10 illustrates a block diagram 1000 for generation of stimulus signals to produce haptic sensations using remotely located actuators. Computation unit 1006 can receive a channel matrix H (e.g., as output at 912) at 1002 and a spatio-temporal stimulus pattern (e.g., if the system is producing sensations to be perceived multiple locations) at 1004. Computation unit 1006 can use these to generate per-channel output waveforms. For example, this can be done by computing the pseudo-inverse of the channel matrix and applying power normalization. The output waveforms for each transducer can be computed by calculating an inverse Fourier transform of the per frequency source signal matrix. The digital waveforms can be passed to the M channel DAC 1010 to convert the digital waveforms to analog waveforms at 1012. The analog waveforms can be amplified by amplifier array 1014, which at 1016 are then provided to the corresponding transducers of transducer array 1018. Transmission of the amplified waveforms by the transducers generates the desired displacements at the target vectors.

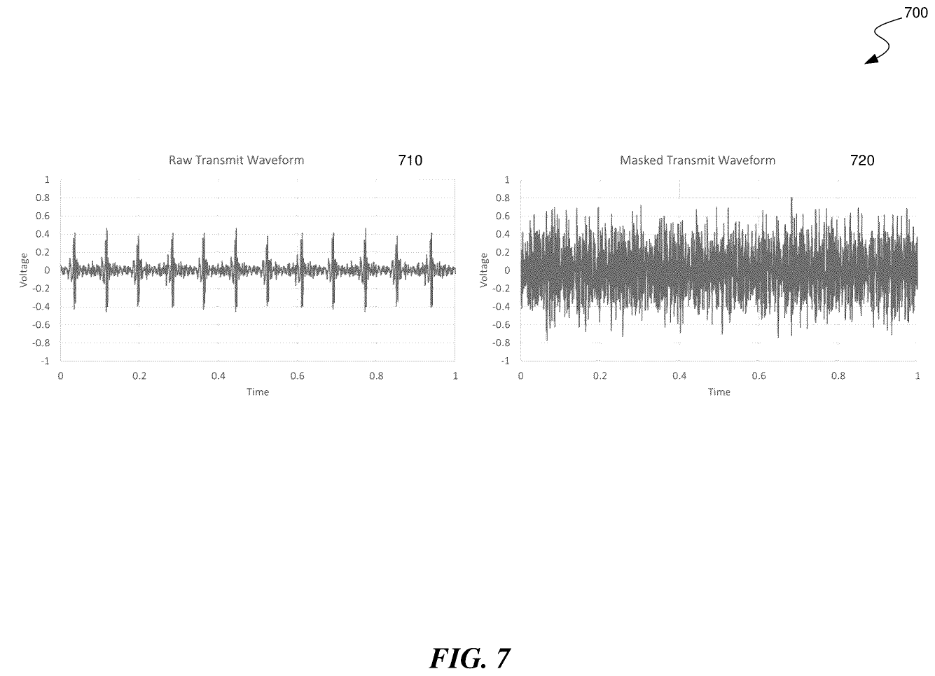

The signal waveforms are then multiplied by the precoder matrix and transmitted along with the masking waveforms to the transducer array. FIG. 7 illustrates an example 700 of an initial raw transmit waveform 710, with a mask applied becoming masked transmit waveform 720.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

In various implementations, the technology can include a device which includes a database of maps of the heterogeneous dispersion and attenuation of a region of the human body which includes the area of intended remote haptic stimulation and the region where the array of transducers is worn; and selects an appropriate map using calibration data and various other critical information; and uses the selected map to predict the channel response between each transducer in an array and each target vector; to enable beamforming of mechanical waves for the purpose of stimulating mechanoreceptors at a distance beyond their receptive fields. In some implementations, the device can be configured to track the pose of the region of the body to generate one type of critical information. In some implementations, the device can be configured to collect anthropometric data on the region of the body to generate one type of critical information. In some implementations, the device can include sensors at each transducer and/or the use of bidirectional transducers which allow collection of channel response data from a stimulus applied within the region of the body, such that the channel response between the transducer acting as an emitter and the stimulus location acting as a target can be calculated through a known transfer function and used as calibration data. In some implementations, a smartphone application can provide a user instructions for calibration which include the placement of specific parts of the region of the body in contact with the smartphone and the transmission of sounding signals via the smartphone inbuilt vibration motor or speaker. In some cases, a user can wear a secondary device on a part of the body which includes a sensor for the purpose of calibration which measures a sounding signal sent from one or more transducers from the first device and transmits this channel data for use in calibration to the first device. In some cases, the secondary device can be a ring worn on a finger or toe. In some cases, the sensor is an IMU with the IMU mounted in the secondary device in such a way that waves propagating through the region of the body are detected by the IMU. In some implementations, a Seebeck effect power the secondary device, which provides a wireless link to transmit information to the device performing the calibration computation. In some implementations, the sensor is placed in a distal section of the device.

In various implementations, the technology can include a method comprising: using a database of maps of the dispersion and attenuation of the human body, to select an appropriate map using calibration and other critical information; and using the selected map to calculate the channel response between each transducer in an array of multiple transducers and each desired target vector in the vicinity of one or more target mechanoreceptors to be stimulated from a distance beyond their receptive fields. In some implementations, the method is performed with a database of dispersion and attenuation maps, generated from a large dataset of measured user dispersion and attenuation data for each displacement vector. In some cases, the method uses a known external stimulus and paired sensors on each transducer or bidirectional transducers with a known transfer function to generate calibration data containing the channel response from the stimulus location and each transducer. In some implementations, the method uses data collected from a sensor in the region of the body of remote haptic stimulation and a known stimulus transmitted by a given transducer to provide calibration data containing the channel response between a given transducer and the location of the sensor. In some implementations, the method includes selecting maps of dispersion and attenuation from the database and adjusting, by comparing collected anthropometric, calibration and other critical data collected on the user against the similar fields of the database. In some implementations, the method includes predicting the attenuation and dispersion map of a given target region, using machine learning and based on anthropometric, calibration and other critical data collected. In some implementations, the method includes estimating a channel response between each transducer in the array and a targeted vector by applying a mathematical operation on a selected map of dispersion and attenuation and the collected pose information of the region of the body.

I/We claim:

1. A haptics device comprising:
an array of multiple transducers;
wherein one or more of the multiple transducers transmit a specific mechanical waveform;
wherein two or more of the waveforms are selected such that, after propagating through a human body channel medium, the two or more of the waveforms combine at one or more target locations to generate one or more selected subsurface strains which deform one or more target mechanoreceptors; and
wherein the array of multiple transducers are located remotely, from the one or more target locations of the mechanoreceptors, beyond the receptive fields of the mechanoreceptors.

2. The haptics device of claim 1, wherein generation of a selected subsurface strain is achieved by targeting two or more displacement vectors at the one or more target locations.

3. The haptics device of claim 1,
wherein each of the multiple transducers is a voice coil, bone conduction transducer, or piezo transducer; and
wherein each of the multiple transducers has a frequency of operation between 50 Hz and 1 kHz.

4. The haptics device of claim 1, wherein one or more of the multiple transducers is a piezo transducer with a frequency of operation between 10 kHz and 1 MHz.

5. The haptics device of claim 1, wherein the haptics device is worn on a wrist of a user and the one or more target locations are in a hand of the user.

6. The haptics device of claim 1, wherein the haptics device is integrated into a head-mounted device and the one or more target locations are on a face of a user wearing the head-mounted device.

7. The haptics device of claim 1, wherein the multiple transducers include at least eight transducers.

8. The haptics device of claim 1, wherein the one or more target mechanoreceptors are rapidly adapting mechanoreceptors.

9. The haptics device of claim 1 further comprising means for minimizing local stimulation while maximizing energy coupling into the flesh.

10. The haptics device of claim 1 further comprising means, located adjacent to at least some of the multiple transducers, for stimulating a lateral inhibition in one or more mechanoreceptor.

11. A method comprising:
determining waveforms for independent control of two or more target vectors directed at one or more target locations to generate one or more selected subsurface strains which deform one or more target mechanoreceptors from a distance beyond the receptive fields of the one or more target mechanoreceptors; and
transmitting, by an array of multiple transducers, the determined waveforms that stimulate the one or more target mechanoreceptors.

12. The method of claim 11, wherein the two or more target vectors are determined by calculating surface displacement vectors which result in a desired subsurface strain field which maximally stimulates the target one or more mechanoreceptors.

13. The method of claim 12, wherein the displacement vectors include opposing tangential or normal components.

14. The method of claim 12, wherein the calculation of target surface displacement uses an analytical model.

15. The method of claim 11, wherein the determining waveforms includes calculating a target spatio-temporal displacement pattern by applying a simulation of one or more mechanoreceptors.

16. The method of claim 11, wherein determining a waveform for each of two or more of the multiple transducers, is performed by determining an orthogonal basis between the two or more target vectors.

17. The method of claim 11, wherein the transmitting the determined waveforms includes spatial focusing waves utilizing dispersion of a channel.

18. The method of claim 11, wherein the two or more target vectors are selected by determining a spatio-temporal displacement pattern, in the one or more target locations, which variably triggers one or more target mechanoreceptors.

19. The method of claim 11, wherein the determining the waveforms includes determining a frequency range of operation and waveform shapes that maximally transfer energy to the one or more target locations while minimizing stimulation local to the multiple transducers.

20. The method of claim 11, wherein the determining the waveforms include adding one or more suppression waveforms, to inhibit local stimulation local to the multiple transducers, with an amplitude between 1 time and 5 times greater than corresponding waveforms that focus the target vectors on the one or more target locations.

21. The method of claim 11, wherein the determining the waveforms include providing one or more suppression waveforms, to inhibit local stimulation local to the multiple transducers, that precede or are synchronized with corresponding waveforms that focus the target vectors on the one or more target locations.
